(19) United States
(12) Patent Application Publication
(10) Pub. No.: US 2023/0412379 A1
(43) Pub. Date: Dec. 21, 2023

(54) ANONYMOUS TOKEN ENHANCEMENTS

(71) Applicant: VMware, Inc., Palo Alto, CA (US)

(72) Inventor: Avishay YANAI, Herzliya (IL)

(21) Appl. No.: 17/807,756

(22) Filed: Jun. 20, 2022

(51) Int. Cl. H04L 9/32; H04L 9/08

(52) U.S. Cl. CPC H04L 9/3213; H04L 9/3271; H04L 9/0869

(57) ABSTRACT

The disclosure provides an approach for anonymous access control. Embodiments include receiving, by a client device Cᵢ of a plurality of client devices, from a server, a first table R comprising a plurality of rows. Each row R(j) of the plurality of rows corresponds to a client device Cⱼ of the plurality of client devices. Each row R(j) comprises a public encryption key ekⱼ corresponding to the client device Cⱼ, a commitment cmⱼ that is based on a token budget tⱼ of the client device Cⱼ and a random value rⱼ, and a ciphertext ctⱼ that is an encryption of the random value rⱼ using the public encryption key ekⱼ. Embodiments include generating, by the client device Cᵢ, based on the table R, a new table R′ comprising a new plurality of rows. Embodiments include sending R and R′ to the server in association with a request.

### BACKGROUND

Access control is an important component in computing applications. For example, access tokens may be utilized to control access to secure resources such as data and application logic.

An access token is an object whose holder is permitted to perform some operations in a system. For example, in single-sign-on (SSO) services, there is one entity that is responsible for authenticating users, and if authentication is successful for a user, the user is given an access token with which it can access one or more services. Typically, an access token contains user identification information as well as additional information such as a timestamp, an expiration time, a signature of an authenticator, and/or the like. When a user uses its access token to access a service, the service provider verifies that one or more parameters related to the token are valid (e.g. that the token is not expired) and that it is signed by the authenticator (to prevent malicious users from crafting their own access tokens).

In some cases, however, it may be desirable to allow anonymity for users such that a service is unable to determine which user has submitted an access token to access a secure resource. For example, upon authentication a user may be given an anonymous token. This anonymous token allows the user to use a service without revealing its identity. While there are existing techniques for providing anonymous tokens, these techniques have certain drawbacks. For example, some existing anonymous token implementations involve a signature on a random nonce. However, when the user requests access from a service by providing such a token to the service, the service can compare the nonce (number) in the token to a database of the authenticator and learn which user was given that number in its token.

In another example, an authenticator signs on the same number for the tokens of all users. While this may prevent the service from distinguishing between users, additional problems are presented. For example, once a token that contains a signature on some arbitrary number (which is the same for all tokens) is publicly revealed, anyone can use it to access that service without prior authentication. Furthermore, such a token provides access to the service for an unlimited amount of time, since putting an expiration time on the token may allow the service to identify the user. For example, if the expiration time is one week after the token's creation, then upon receiving a valid token the authenticator knows that it was created for a user that interacted with the authenticator within the past week.

As such, there is a need in the art for improved techniques for anonymous access control.

### BRIEF DESCRIPTION OF THE DRAWINGS

FIG. 1 illustrates example computing components related to anonymous access control.

FIG. 2 illustrates an example related to anonymous access control.

FIG. 3 illustrates example characteristics of techniques for anonymous access control.

FIG. 4 depicts example operations related to anonymous access control.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for anonymous access control, particularly through improved techniques for generating anonymous tokens.

### Overview of Anonymous Credentials and Anonymous Tokens

The problem of anonymous tokens is a sub-class of a larger class of problems, called anonymous credentials (or attribute based credentials), in which a user is given a credential that contains several attributes and then, to access a service, the user is able to prove that the user's credential contains certain prerequisite properties (e.g., a credential that is given only to employees of an organization may be different than credentials given to non-employees). There are many existing solutions to the general problem of anonymous credentials. However, the focus of the present disclosure is on the specific problem of anonymous tokens.

One existing solution for anonymous tokens uses an Oblivious Pseudorandom Function (OPRF) protocol as a building block. A function F is pseudorandom if, given q=p(K) function results O(xₗ), . . . , O(x_{q}), where p is some polynomial and K is the security parameter (the length of a key k), an adversary (who chooses xₗ, . . . , x_{q}) cannot determine if O is the function F(k, ·) or some random process ƒ(·) that outputs a truly random value on each input.

An OPRF is a two-party protocol between a client and a server where the server has a secret key k and the client has a secret query x. The result of the protocol is F(k, x) for the client and nothing for the server.

One existing scheme for anonymous tokens is based on OPRF as follows. Upon a successful (either anonymous or non-anonymous) authentication, the server and the client run t instances of the OPRF protocol, where t is the access limit (or ‘budget’) of the client (e.g., the client can access services that are associated with the server at most t times). In the i-th run, the client picks a random value x; and obtains the result y, =F(k, xᵢ). The server does not know the value of xᵢ and yet the client obtains the correct result. When a client wants to ‘spend’ a token, it shows the service provider a pair (xⱼ, yⱼ) for some j∈ {1, . . . , t}. The service provider verifies that yⱼ=F(k, xⱼ), and also that (xⱼ, yⱼ) was not previously spent. If verification succeeds, the service provider grants access to that user. The problem is that the server has to verify that the token (or pair) (xⱼ, yⱼ) was not previously spent, and this is done by having the server store the set of all tokens that have ever been spent. This means that the server's storage increases with the number of tokens, which, after some time, may become difficult to maintain. Furthermore, in some contexts (e.g., when the server is an internet of things (IOT) device or otherwise has limited storage resources, such storage may not be available). The same disadvantage (e.g., large amounts of storage utilization) exists in other solutions based on zero knowledge proofs, like those used in certain types of anonymous cryptocurrencies. This disadvantage could be mitigated by the server replacing its private key from k to k′ when its storage capacity has been reached, and from that point on accepting only tokens that relate to the new key k′ (e.g., (x,y) s·t·y=F(k′,x)). This would allow the server to discard the tokens that it has collected so far. However, to do so, the server would need to first re-issue unspent token relating to the older key k and transform them so they relate to the new key k′. This would require interaction with all clients that still hold unspent tokens, which may be an issue (e.g., if some clients are offline).

### Improved Anonymous Token Techniques

To address the issues identified above with existing anonymous token techniques, embodiments of the present disclosure involve new anonymous token techniques that maintain anonymity of users and allow limits on token usage while reducing the amount of storage resources required. In particular, the improved anonymous token techniques described herein do not cause the data stored on the server to grow with the number of (spent) tokens. For example, while existing techniques require O(T) storage on the server, where T is the total number of spent tokens, improved techniques described herein only require O(N) storage on the server, where N is the number of clients to which tokens are issued.

Embodiments of the present disclosure involve the concepts of unlinkable homomorphic commitment, unlinkable homomorphic encryption, and zero knowledge proof.

A commitment is a cryptographic primitive that allows a party to commit to a value v but to keep it hidden. Then, at a later point, the party can open v but it cannot open it to another value v′≠v. The former property is referred as the hiding property and the later property is the binding property.

To generate a commitment, the party uses a randomness, so the commitment on a value v using randomness r is cm=Com(v, r), where “Com” is a commitment function. Since r is chosen from a large domain, it is not possible to learn v from cm. To open cm, the committer can simply send v and r and the receiver verifies that Com(v, r)=cm. A commitment scheme is homomorphic if for every v₁, v₂, rᵢ, r₂, Com(v₁, rᵢ) Com(v₂, r₂)=Com(v₁+v₂, rᵢ+r₂), where is a composition operator. An unlinkable commitment is a commitment scheme for which the pair (Com(v₁, rᵢ), Com(v₁+v₂, rᵢ+r₂)) is indistinguishable from the pair Com(v₁, rᵢ), Com(v₃, r₃) to anyone who does not posses r₂ or r₃. Techniques for unlinkable homomorphic commitment are known in the art, and any such technique may potentially be utilized with embodiments of the present disclosure.

An encryption allows one to hide a value such that only the one who has the decryption key can reveal it. Formally, the ciphertexts ctᵢ=Enc(ek, v₁) and ct₂=Enc(ek, v₂) are indistinguishable to anyone who does not have ek's matching decryption key dk (even if v₁ and v₂ are known), where “Enc” is a randomized encryption function and ek is an encryption key. An encryption scheme is (additively) homomorphic if for every ek, v₁, v₂, Enc(ek, v₁) Enc(ek, v₂)=Enc(ek, v₁+v₂). An unlinkable encryption is an encryption scheme for which the pair Enc(ek, v₁), Enc(ek, v₁+v₂) is indistinguishable from the pair Enc(ek, v₁), Enc(ek, v₃) to anyone who does not possess the randomness used to produce Enc(ek, v₁+v₂) or Enc(ek, v₃). Techniques for unlinkable homomorphic encryption are known in the art, and any such technique may potentially be utilized with embodiments of the present disclosure.

A zero-knowledge proof scheme, as known in the art, allows a prover to prove a statement without revealing private information about the statement. For example, a zero knowledge proof Z may allow a party to prove that it knows x such that 0=SHA256(x) (e.g., that the party knows a preimage of zero) without revealing the value of x. Techniques for generating zero knowledge proofs are known in the art, and any such technique may potentially be utilized with embodiments of the present disclosure (in the context of this document, some techniques might be more suitable and efficient than others).

The improved anonymous token techniques proposed herein rely on a public key infrastructure (PKI), and, in some embodiments, involve the use of unlinkable homomorphic commitment, unlinkable homomorphic encryption, and/or zero knowledge proof.

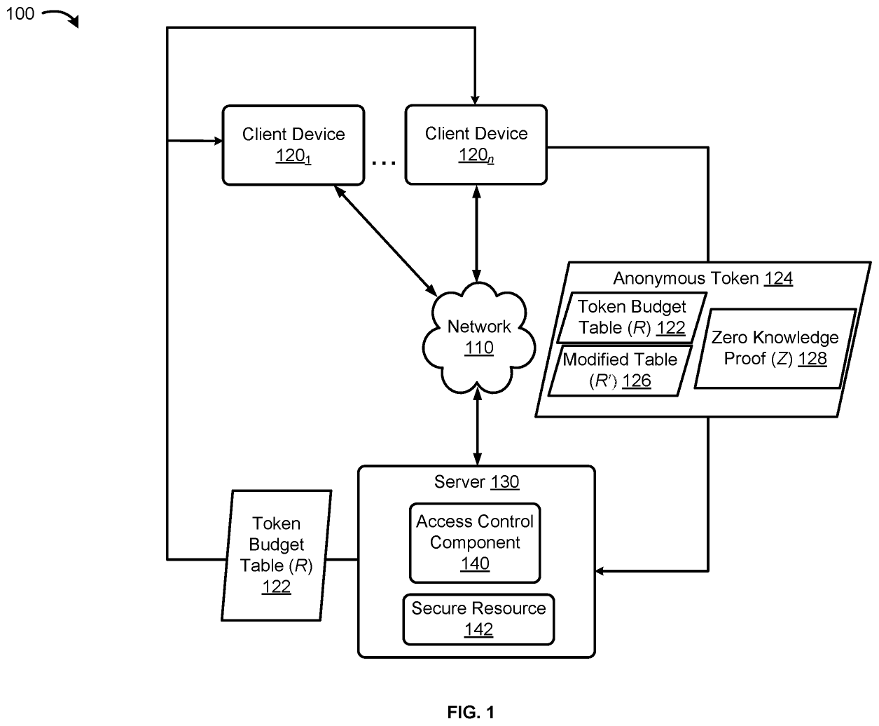

Specifically, as described in more detail below with respect to FIGS. 1-4, techniques described herein involve a server generating a token budget table R that stores public encryption keys ekᵢ for a plurality of clients Cᵢ, along with commitments cmᵢ (e.g., committing token budgets tᵢ with random values rᵢ) and ciphertexts ctᵢ (e.g., generated by encrypting random values rᵢ using encryption keys ekᵢ). A given client Cᵢ may receive table R and generate a modified table R′ (e.g., using unlinkable homomorphic commitment and unlinkable homomorphic encryption) that reduces the client's token budget by one without affecting token budgets of other clients in such a manner that the server is unable to determine based on R′ which client Cᵢ is submitting the anonymous token. Furthermore, the client Cᵢ may generate a zero knowledge proof Z, such as attesting that R′ reduces the token budget of the corresponding (anonymous) client by one without affecting token budgets of other clients. The client Cᵢ may send R, R′, and Z as an anonymous token to the server, and the server may verify Z over R and R′ to determine whether to grant client Cᵢ access to a secure resource without knowing the identity of client Cᵢ.

FIG. 1 is an illustration 100 of example computing components related to anonymous access control.

In illustration 100, a plurality of client devices 120₁-n (which may be referred to collectively as client devices 120 and individually as client device 120) and a server 130 are connected via a network 110. Network 110 may, for example, be a local area network (LAN) a wide area network (WAN), and/or the like. Client devices 120 and server 130 may each be computing devices with one or more processors, memory, and/or the like, and/or may be implemented as software running on one or more physical computing devices with one or more processors, memory, and/or the like. Client devices 120 generally represent computing devices (e.g., desktop or laptop computers, mobile devices, virtual computing instances, and/or the like) associated with users of one or more software applications. For example, client devices 120 may utilize anonymous token techniques described herein to access a secure resource 142 on server 130. Secure resource 142 may, for example, be an item of data, a service, and/or the like.

In a particular example, a public key infrastructure (PKI) is used in which each client device 120ᵢ has a public encryption key ekᵢ (which may be known publicly, such as by server 130 and/or other clients) and a private decryption key dkᵢ (which may be known only to client device 120ᵢ). An access control component 140 on server 130 utilizes the public encryption keys ekᵢ to generate a token budget table 122 (which may be referred to as table R) for issuing tokens to client devices 120. Token budget table 122 is provided by server 130 to all client devices 120 (e.g., by transmitting token budget table 122 to each client 120 or otherwise making token budget table 122 available to client devices 120 (e.g., by publishing token budget table 122 to a database, blockchain, or other type of public data storage entity).

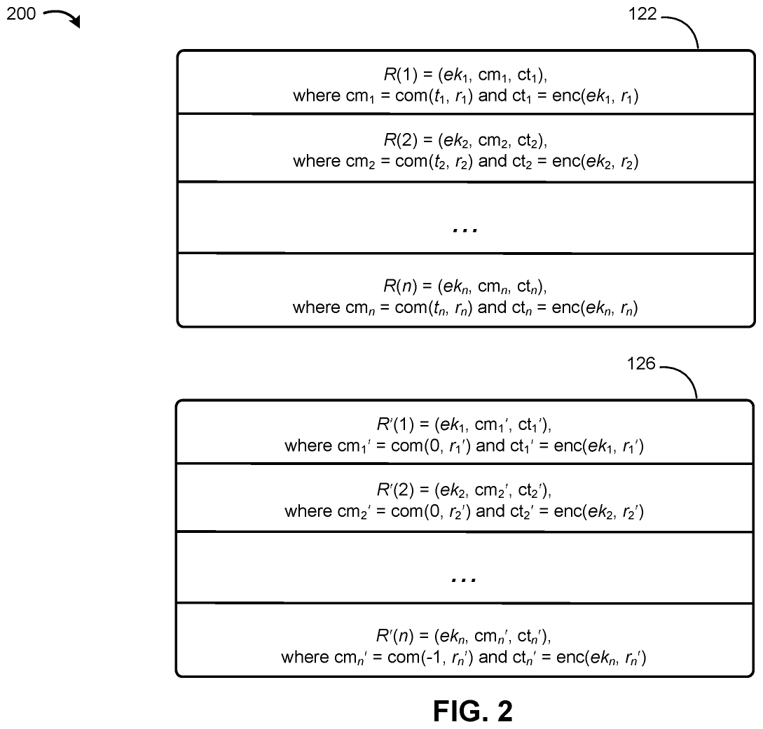

For example, as described in more detail below with respect to FIG. 2, to issue t tokens for every client (resulting in a total number of T tokens for all clients), the server creates table R with N rows (N being the number of clients), where row number i, denoted R(i), is associated with the i-th client and contains: R(i)=(ekᵢ, cmᵢ, ctᵢ)=(ekᵢ, Com(t, rᵢ), Enc(ekᵢ, rᵢ)).

To spend a token (e.g., to use a token in a client's budget to access secure resource 142), client Cᵢ(e.g., corresponding to a client device 120ᵢ) retrieves table R (e.g., from server 130) and generates a modified table 126 (which be referred to as new table R′) based on table R.

For example, for every row j, client Cᵢ may parse R(j)=ekⱼ, cmⱼ, ctⱼ, where cmᵢ is a commitment on the current ‘budget’, tⱼ, of Cⱼ, with randomness rⱼ, and ctⱼ is an encryption of rⱼ using the encryption key ekⱼ. In addition, for the i-th row, the client Cᵢ may compute rᵢ=Dec(dkᵢ, ctᵢ) as client Cᵢ knows dkᵢ.

As described in more detail below with respect to FIG. 2, client Cᵢ may create table R′ such that:

R(j≠i)=(ekⱼ,cmⱼ′,ctⱼ′)=(ekⱼ,cmⱼ·Com(0,rⱼ′),ctⱼ·Enc(ekⱼ,rⱼ′))=(ekⱼ,Com(tⱼ,rⱼ+rⱼ′),Enc(ekⱼ,rⱼ′+rⱼ′)); and

R(i)=(ekᵢ,cmᵢ′,ctᵢ′)=(ekᵢ,cmᵢ·Com(−1,r₁′),ctᵢ·Enc(ekᵢ,r₁′))=(ekᵢ,Com(tᵢ,r₁+r₁′),Enc(ekᵢ,r₁′+rᵢ′))

For example, each “Com” operation may be an unlinkable homomorphic commitment operation, and each “Enc” operation may be an unlinkable homomorphic encryption operation. The only difference between rows j≠i and row i is that in the former the client does not change the budget (adding 0 to the committed value) whereas in the latter the client decreases the budget by one (by adding −1 to the committed value). In addition, client Cᵢ is able to determine the randomness rⱼ of the commitment for ctᵢ only where j=i.

Furthermore, client Cᵢ may create a zero knowledge proof 128 (which may be referred to as zero knowledge proof Z). For example, zero knowledge proof Z may attest to the following statement that involves R and R′: For every row i one of the following conditions holds:
(a) cmᵢ and cmᵢ′ are commitments to the same value and the randomness of cmᵢ′ is encrypted in ctᵢ′; or
(b) the value committed in cmᵢ is greater by 1 than the value committed in cmᵢ′, the value committed in cmᵢ is not zero, the randomness of cmᵢ′ is encrypted in ctᵢ′, (optionally) client Cᵢ knows the randomness of cmᵢ′, and, in some embodiments, (optionally) client Cᵢ knows the randomness of cmᵢ.

The client Cᵢ does not specify which of the two conditions holds, and since it knows the randomness of at most one row (R(i)), that means that the first condition holds for all rows R(j) for which j≠i.

The client C; sends token=(R, R′, Z) to the server, and the server may verify that: (a) R is the table currently stored locally by the server; and (b) Z is verified successfully over R and R′. The server grants access to the client Cᵢ if the verification succeeds.

For example, client device 120ₙ sends anonymous token 124, comprising token budget table 122 (R), modified token budget table 126 (R′), and zero knowledge proof 128 (Z), to server 130, and access control component 140 may determine whether to allow client device 120ₙ to access secure resource 142 based on anonymous token 124.

FIG. 2 is an illustration 200 of an example related to anonymous access control. For example, illustration 200 depicts additional details related to token budget table 122 (R) and modified table 126 (R′) of FIG. 1.

Token budget table 122 includes a plurality of rows R(1)-R(n). For example, row R(1)=(ek₁, cm₁, ct₁), where cm₁=com(t₁, r₁) and ct₁=enc(ek₁, r₁). Similarly, row R(2)=(ek₂, cm₂, ct₂), where cm₂=com(t₂, r₂) and ct₂=enc(ek₂, r₂). Finally, row R(n)=(ekₙ, cmₙ, ctₙ), where cmₙ=com(tₙ, rₙ) and ctₙ=enc(ekₙ, rₙ).

Token budget table 122 (table R) represents the token budgets of each of client devices 120₁₋ₙ of FIG. 1, and the values t₁₋ₙ represent numbers of tokens issued to each client device 120. As described above, with respect to FIG. 1, a client (e.g., client device 120ₙ of FIG. 1) spends a token in its budget by generating a modified table R′ based on table R and sending an anonymous token comprising R, R′, and a zero knowledge proof Z to the server.

For example, client device 120ₙ of FIG. 1 may generate modified table 126 based on token budget table 122, in which the budget of client device 120ₙ is decreased by one (e.g., by committing the value of −1 in row R′ (n) corresponding to client device 120ₙ) while the budgets of other client devices are left unaltered (by committing the value of 0 in other rows of R′ corresponding to other client devices 120 of FIG. 1).

Thus, modified table 126 includes a plurality of rows R′(1)- R′(n). For example, row R′(1)=(ek₁, cm₁′, ct₁′), where cmᵢ′=com(0, r₁′) and ct₁′=enc(ek₁, r₁′). Similarly, row R′(2)=(ek₂, cm₂, ct₂′), where cm₂′=com(0, r₂′) and ct₂′=enc(ek₂, r₂′). Finally, row R′(n)=(ekₙ, cmₙ′, ctₙ′), where cmₙ′=com(−1, rₙ′) and ctₙ′=enc(ekₙ, rₙ′).

Commitments cm₁₋ₙ′ may be generated using unlinkable homomorphic commitment. Ciphertexts ct₁₋ₙ′ may be generated using unlinkable homomorphic encryption.

The reason that rows other than row R′(n) are modified in modified table 126 is so that the server will be unable to determine which client generated modified table 126. For example, if client device 120ₙ of FIG. 1 only changed row R′(n) with respect to the original table, then the server would be able to tell based on which row was altered that client device 120ₙ generated modified table 126, which would defeat the anonymity of the token. Thus, techniques described herein provide improved anonymity by involving modification of all rows of R′ as compared to R.

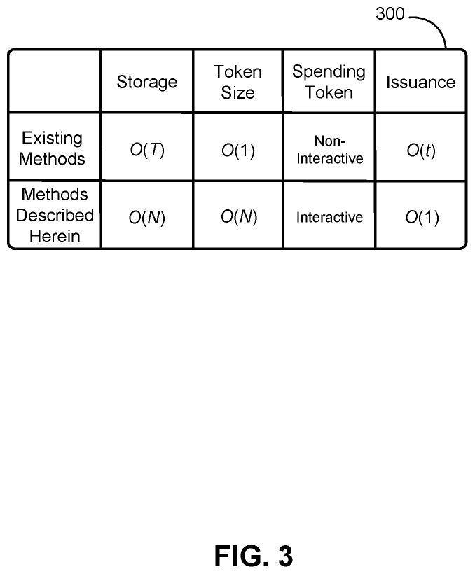

FIG. 3 depicts a table 300 of example characteristics of techniques for anonymous access control. For example, table 300 compares characteristics of existing methods for anonymous access control with characteristics of methods described herein.

As shown in table 300, existing techniques for anonymous access control, such as involving oblivious pseudorandom function (OPRF) protocols, have a storage resource cost at the server of O(T), where Tis the total number of tokens issued to all clients. The number T can grow quite large as multiple tokens may be issued to each client on an ongoing basis. This O(T) storage cost may be prohibitively large in certain cases, such as for devices with limited storage resources (e.g., internet of things (IOT) devices).

By contrast, techniques described herein for anonymous access control have a storage resource cost at the server of O(N), where N is the total number of clients. T can grow much larger than N as large numbers of tokens may potentially be issued to each client. As such, embodiments of the present disclosure potentially require a significantly smaller amount of data to be stored at the server, thereby rendering techniques described herein better suited to contexts in which storage resources are limited (e.g., for IOT devices).

Existing techniques may have a lower token size O(1) than embodiments of the present disclosure, which involve a token size O(N). Also, embodiments of the present disclosure are interactive (e.g., involving more than one message between the client and server to spend a token, in order for the client to retrieve the most recent state of the budget table R), while existing techniques are generally non-interactive (e.g., not requiring more than one message between the client and the server to spend a token). However, embodiments of the present disclosure may still be preferable to existing techniques in cases where storage resources at the server are limited. In particular, techniques described herein overcome the technical problem of implementing anonymous access control by a server that has limited available storage resources.

Additionally, embodiments of the present disclosure have a lower token issuance cost than existing techniques. For example, issuing tokens in existing techniques has a cost of O(t), where t is the number of tokens issued to each client in a batch. Advantageously, issuing tokens in embodiments of the present disclosure has a cost of O(1). Thus, techniques described herein may greatly reduce the amount of computing resources required to issue anonymous tokens.

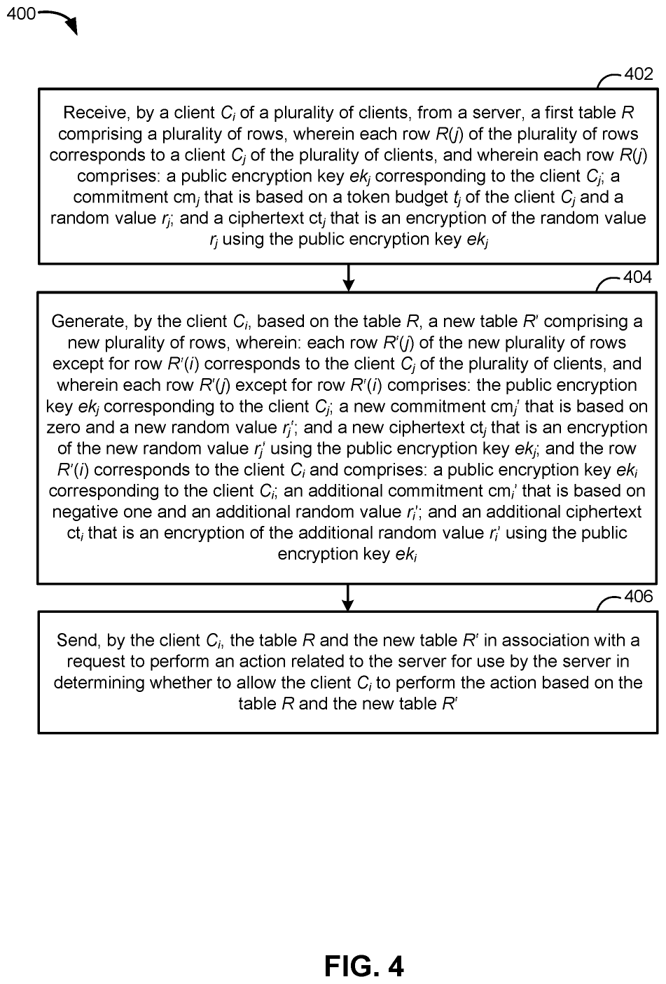

FIG. 4 depicts example operations 400 related to anonymous access control. For example, operations 400 may be performed by one or more components of server 130 and/or client device 120 of FIG. 1.

Operations 400 begin at step 402, with receiving, by a client device C; of a plurality of client devices, from a server, a first table R comprising a plurality of rows. In some embodiments, each row R(j) of the plurality of rows corresponds to a client device Cⱼ of the plurality of client devices, and wherein each row R(j) comprises: a public encryption key ekⱼ corresponding to the client device Cⱼ; a commitment cmⱼ that is based on a token budget tⱼ of the client device Cⱼ and a random value rⱼ; and a ciphertext ctⱼ that is an encryption of the random value rⱼ using the public encryption key ekⱼ.

Operations 400 continue at step 404, with generating, by the client device Cᵢ, based on the table R, a new table R′ comprising a new plurality of rows. In some embodiments, each row R′j) of the new plurality of rows except for row R′(i) corresponds to the client device Cⱼ of the plurality of client devices, and each row R′(j) except for row R′(i) comprises: the public encryption key ekⱼ corresponding to the client device Cⱼ; a new commitment cmⱼ′ that is based on zero and a new random value rⱼ′; and a new ciphertext ctⱼ that is an encryption of the new random value rⱼ′ using the public encryption key ekⱼ. In certain embodiments, the row R′(i) corresponds to the client device Cᵢ and comprises: a public encryption key ekᵢ corresponding to the client device Cᵢ; an additional commitment cmᵢ′ that is based on negative one and an additional random value rᵢ′; and an additional ciphertext ctᵢ that is an encryption of the additional random value rᵢ′ using the public encryption key ekᵢ.

In some embodiments, each new commitment cmⱼ′, including the additional commitment cmᵢ′, is generated using unlinkable homomorphic commitment. In certain embodiments, each new ciphertext ctⱼ′, including the additional ciphertext ctᵢ′, is generated using unlinkable homomorphic encryption.

Operations 400 continue at step 406, with sending, by the client device Cᵢ, the table R and the new table R′ in association with a request to perform an action related to the server for use by the server in determining whether to allow the client device C; to perform the action based on the table R and the new table R′.

Some embodiments further comprise generating, by the client device Cᵢ, a zero knowledge proof Z attesting that, for each row n in tables R and R′: a value committed in cmₙ is greater by one than a corresponding value indicated by cmₙ′; or a value committed in cmₙ is equal to a corresponding value indicated by cmₙ′. Certain embodiments further comprise sending, by the client device Cᵢ, the zero knowledge proof Z to the server.

For example, the table R, the new table R′, and the zero knowledge proof Z may be components of a token used by the server in determining whether to allow the client device Cᵢ to perform the action.

Some embodiments, further comprise decrypting, by the client device Cᵢ, a respective ciphertext ctᵢ included in the table R using a decryption key dkᵢ that is stored by the client device Cᵢ in order to determine a respective random value rᵢ. For example, the zero knowledge proof Z may be further based on the respective random value rᵢ (e.g., attesting that client device Cᵢ knows the respective random value rᵢ). Furthermore, in some embodiments client device Cᵢ may determine token budget tᵢ of the client device Cᵢ based on the decryption and confirm that the token budget tᵢ is not zero. In certain embodiments, the zero knowledge proof Z may be further based on the token budget tᵢ (e.g., attesting that the token budget tᵢ is not zero).

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) —CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of anonymous access control, comprising:
receiving, by a client device Cᵢ of a plurality of client devices, from a server, a first table R comprising a plurality of rows, wherein each row R(j) of the plurality of rows corresponds to a client device Cⱼ of the plurality of client devices, and wherein each row R(j) comprises:
a public encryption key ekⱼ corresponding to the client device Cⱼ;
a commitment cmⱼ that is based on a token budget tⱼ of the client device Cⱼ and a random value rⱼ; and
a ciphertext ctⱼ that is an encryption of the random value rⱼ using the public encryption key ekⱼ;
generating, by the client device Cᵢ, based on the table R, a new table R′ comprising a new plurality of rows, wherein:
each row R′(j) of the new plurality of rows except for row R′(i) corresponds to the client device Cⱼ of the plurality of client devices, and wherein each row R′(j) except for row R′(i) comprises:
the public encryption key ekⱼ corresponding to the client device Cⱼ;
a new commitment cmⱼ′ that is based on zero and a new random value rⱼ′; and
a new ciphertext ctⱼ that is an encryption of the new random value rⱼ′ using the public encryption key ekⱼ; and
the row R′(i) corresponds to the client device Cᵢ and comprises:
a public encryption key ekᵢ corresponding to the client device Cᵢ;
an additional commitment cmᵢ′ that is based on negative one and an additional random value rᵢ′; and
an additional ciphertext ctᵢ that is an encryption of the additional random value rᵢ′ using the public encryption key ekᵢ; and
sending, by the client device Cᵢ, the table R and the new table R′ in association with a request to perform an action related to the server for use by the server in determining whether to allow the client device Cᵢ to perform the action based on the table R and the new table R′.

2. The method of claim 1, further comprising generating, by the client device Cᵢ, a zero knowledge proof Z attesting that, for each row n in tables R and R′:
a value committed in cmₙ is greater by one than a corresponding value indicated by cmₙⁱ′; or
a value committed in cmₙ is equal to a corresponding value indicated by cmₙ′.

3. The method of claim 2, further comprising sending, by the client device Cᵢ, the zero knowledge proof Z to the server.

4. The method of claim 3, wherein the table R, the new table R′, and the zero knowledge proof Z are components of a token used by the server in determining whether to allow the client device C; to perform the action.

5. The method of claim 2, further comprising decrypting, by the client device Cᵢ, a respective ciphertext ctᵢ included in the table R using a decryption key dkᵢ that is stored by the client device Cᵢ in order to determine a respective random value rᵢ.

6. The method of claim 5, wherein the zero knowledge proof Z is further based on the respective random value rᵢ.

7. The method of claim 1, wherein:
each new commitment cmⱼ′, including the additional commitment cmᵢ′, is generated using unlinkable homomorphic commitment; and
each new ciphertext ctⱼ′, including the additional ciphertext ctᵢ′, is generated using unlinkable homomorphic encryption.

8. A system for anonymous access control, the system comprising:
at least one memory; and
at least one processor coupled to the at least one memory, the at least one processor and the at least one memory configured to:
receive, by a client device Cᵢ of a plurality of client devices, from a server, a first table R comprising a plurality of rows, wherein each row R(j) of the plurality of rows corresponds to a client device Cⱼ of the plurality of client devices, and wherein each row R(j) comprises:
a public encryption key ekⱼ corresponding to the client device Cⱼ;
a commitment cmⱼ that is based on a token budget tⱼ of the client device Cⱼ and a random value rⱼ; and
a ciphertext ctⱼ that is an encryption of the random value rⱼ using the public encryption key ekⱼ;
generate, by the client device Cᵢ, based on the table R, a new table R′ comprising a new plurality of rows, wherein:
each row R′(j) of the new plurality of rows except for row R′(i) corresponds to the client device Cⱼ of the plurality of client devices, and wherein each row R′(j) except for row R′(i) comprises:
the public encryption key ekⱼ corresponding to the client device Cⱼ;
a new commitment cmⱼ′ that is based on zero and a new random value rⱼ′; and
a new ciphertext ctⱼ that is an encryption of the new random value rⱼ′ using the public encryption key ekⱼ; and
the row R′(i) corresponds to the client device Cᵢ and comprises:
a public encryption key ekᵢ corresponding to the client device Cᵢ;
an additional commitment cmᵢ′ that is based on negative one and an additional random value rᵢ′; and
an additional ciphertext ctᵢ that is an encryption of the additional random value rᵢ′ using the public encryption key ekᵢ; and
send, by the client device Cᵢ, the table R and the new table R′ in association with a request to perform an action related to the server for use by the server in determining whether to allow the client device Cᵢ to perform the action based on the table R and the new table R′.

9. The system of claim 8, wherein the at least one processor and the at least one memory are further configured to generate, by the client device Cᵢ, a zero knowledge proof Z attesting that, for each row n in tables R and R′:
a value committed in cmₙ is greater by one than a corresponding value indicated by cmₙ′; or
a value committed in cmₙ is equal to a corresponding value indicated by cmₙ′.

10. The system of claim 9, wherein the at least one processor and the at least one memory are further configured to send, by the client device Cᵢ, the zero knowledge proof Z to the server.

11. The system of claim 10, wherein the table R, the new table R′, and the zero knowledge proof Z are components of a token used by the server in determining whether to allow the client device Cᵢ to perform the action.

12. The system of claim 9, wherein the at least one processor and the at least one memory are further configured to decrypt, by the client device Cᵢ, a respective ciphertext ctᵢ included in the table R using a decryption key dkᵢ that is stored by the client device Cᵢ in order to determine a respective random value rᵢ.

13. The system of claim 12, wherein the zero knowledge proof Z is further based on the respective random value rᵢ.

14. The system of claim 8, wherein:
each new commitment cmⱼ′, including the additional commitment cmᵢ′, is generated using unlinkable homomorphic commitment; and
each new ciphertext ctⱼ′, including the additional ciphertext ctᵢ′, is generated using unlinkable homomorphic encryption.

15. A non-transitory computer-readable medium storing instructions that, when executed by one or more processors, cause the one or more processors to:
receive, by a client device Cᵢ of a plurality of client devices, from a server, a first table R comprising a plurality of rows, wherein each row R(j) of the plurality of rows corresponds to a client device Cⱼ of the plurality of client devices, and wherein each row R(j) comprises:
a public encryption key ekⱼ corresponding to the client device Cⱼ;
a commitment cmⱼ that is based on a token budget tⱼ of the client device Cⱼ and a random value rⱼ; and
a ciphertext ctⱼ that is an encryption of the random value rⱼ using the public encryption key ekⱼ;
generate, by the client device Cᵢ, based on the table R, a new table R′ comprising a new plurality of rows, wherein:
each row R′(j) of the new plurality of rows except for row R′(i) corresponds to the client device Cⱼ of the plurality of client devices, and wherein each row R′(j) except for row R′(i) comprises:
the public encryption key ekⱼ corresponding to the client device Cⱼ;
a new commitment cmⱼ′ that is based on zero and a new random value rⱼ′; and
a new ciphertext ctⱼ that is an encryption of the new random value rⱼ′ using the public encryption key ekⱼ; and
the row R′(i) corresponds to the client device Cᵢ and comprises:
a public encryption key ekᵢ corresponding to the client device Cᵢ;
an additional commitment cmᵢ′ that is based on negative one and an additional random value rᵢ′; and
an additional ciphertext ctᵢ that is an encryption of the additional random value rᵢ′ using the public encryption key ekᵢ; and
send, by the client device Cᵢ, the table R and the new table R′ in association with a request to perform an action related to the server for use by the server in determining whether to allow the client device Cᵢ to perform the action based on the table R and the new table R′.

16. The non-transitory computer-readable medium of claim 15, wherein the instructions, when executed by the one or more processors, further cause the one or more processors to generate, by the client device Cᵢ, a zero knowledge proof Z attesting that, for each row n in tables R and R′:
a value committed in cmₙ is greater by one than a corresponding value indicated by cmₙ′; or
a value committed in cmₙ is equal to a corresponding value indicated by cmₙ′.

17. The non-transitory computer-readable of claim 16, wherein the instructions, when executed by the one or more processors, further cause the one or more processors to send, by the client device Cᵢ, the zero knowledge proof Z to the server.

18. The non-transitory computer-readable of claim 17, wherein the table R, the new table R′, and the zero knowledge proof Z are components of a token used by the server in determining whether to allow the client device Cᵢ to perform the action.

19. The non-transitory computer-readable of claim 16, wherein the instructions, when executed by the one or more processors, further cause the one or more processors to decrypt, by the client device Cᵢ, a respective ciphertext ctᵢ included in the table R using a decryption key dkᵢ that is stored by the client device Cᵢ in order to determine a respective random value rᵢ.

20. The non-transitory computer-readable of claim 19, wherein the zero knowledge proof Z is further based on the respective random value rᵢ.
